(19) United States
(12) Patent Application Publication
(10) Pub. No.: US 2012/0193095 A1
(43) Pub. Date: Aug. 2, 2012

(54) Hydrocarbon Recovery Operations Fluids and Methods For Using the Same

(76) Inventors: Ramesh Varadaraj, Flemington, NJ (US); Sabine C. Zeilinger, Spring, TX (US); Fred Dupriest, Houston, TX (US)

(21) Appl. No.: 13/394,317

(22) PCT Filed: Aug. 10, 2010
(86) PCT No.: PCT/US10/45038

§ 371 Date: Mar. 5, 2012

Related U.S. Application Data
(60) Provisional application No. 61/252,376, filed on Oct. 16, 2009.

(51) Int. Cl. E21B 43/00; C09K 8/60; C09K 8/32

(52) U.S. Cl. 166/279; 507/131; 507/240

(57) ABSTRACT

Fluids for use in hydrocarbon recovery operations include a non-aqueous fluid and at least one organo-anionic surfactant. The fluids may be used in methods for conducting hydrocarbon recovery operations, such as drilling operations, completion operations, production operations, injection operations. The fluid may be adapted to remediate a NAF filter cake. Exemplary organo-anionic surfactants may include one or more of monoethanol ammonium alkyl aromatic sulfonic acid, monoethanol ammonium alkyl carboxylic acid, and mixtures thereof.

### CROSS REFERENCE TO RELATED APPLICATIONS

This application claims the benefit of U.S. Provisional Application No. 61/252,376 filed Oct. 16, 2009.

### FIELD

The present disclosure relates generally to hydrocarbon recovery operations, including drilling operations, completion operations, production operations, and injection operations. More particularly, the present disclosure relates to fluids and methods for addressing various problems presented by filter cakes during hydrocarbon recovery operations.

### BACKGROUND

This section is intended to introduce the reader to various aspects of art, which may be associated with embodiments of the present invention. This discussion is believed to be helpful in providing the reader with information to facilitate a better understanding of particular techniques of the present invention. Accordingly, it should be understood that these statements are to be read in this light, and not necessarily as admissions of prior art.

For the purposes of the present application, it will be understood that hydrocarbons refers to an organic compound that includes primarily, if not exclusively, the elements hydrogen and carbon. Examples of hydrocarbon-containing materials include any form of natural gas, oil, coal, and bitumen that can be used as a fuel or upgraded into a fuel. Hydrocarbons are commonly found in subsurface formations. As used herein, the term formation refers to a subsurface region, regardless of size, comprising an aggregation of subsurface sedimentary, metamorphic and/or igneous matter, whether consolidated or unconsolidated, and other subsurface matter, whether in a solid, semi-solid, liquid and/or gaseous state. A formation can refer to a single set of related geologic strata of a specific rock type, or to a whole set of geologic strata of different rock types that contribute to or are encountered in, for example, without limitation, (i) the creation, generation and/or entrapment of hydrocarbons or minerals and (ii) the execution of processes used to extract hydrocarbons or minerals from the subsurface.

Operators of hydrocarbon-related wells are engaged in a variety of activities designed to extract hydrocarbons or hydrocarbon-containing materials from a formation. A variety of wells and well types can be drilled into and a variety of operations can be conducted on a single formation in an effort to extract those hydrocarbons. The strategy for the wells and the operations depends on the formation's stage of development, the nature of the formation, and the nature of the hydrocarbon-containing materials in the reservoir associated with the formation, etc. For example, drilling operations may be required to explore the formation and/or to create wells into the formation. Additionally, the wells may be completed, such as by positioning one or more pieces of downhole equipment in the borehole (i.e., the space evacuated by the drilling operation within the wellbore, which refers to the formation face). Still additionally, formation fluids may be produced into the borehole and to the surface. Still additionally, fluids may be injected into the formation from the borehole for a variety of reasons, such as to treat the near-well region of the formation, to drive formation fluids towards another well, to sequester fluids or gases, etc.

Additionally, “hydrocarbon production” refers to any activity associated with extracting hydrocarbons from a well or other opening. Hydrocarbon production normally refers to any activity conducted in or on the well after the well is completed. Accordingly, hydrocarbon production includes not only primary hydrocarbon extraction, but also includes secondary and tertiary production techniques, such as injection of gas or liquid for increasing drive pressure; mobilizing the hydrocarbon or treating by, for example, chemical or hydraulic fracturing of the wellbore to promote increased flow; well servicing; well logging; and other well and wellbore treatments. Despite the diversity of operations that may be performed on a hydrocarbon-related well, for the purposes of this applications, the term hydrocarbon recovery operations will be used to refer to them collectively and individually. For example, the term hydrocarbon recovery operations refers to each and all of drilling operations, completion operations, hydrocarbon production operations, and injection operations (regardless of the fluid being pumped into the borehole or the purpose for which it is being pumped).

There are multiple factors that may limit an operator's ability to conduct hydrocarbon recovery operations at expected or preferred efficiencies. One common factor is the presence of filter cake accumulated on the wellbore and/or downhole equipment in the borehole. Filter cake as used herein may refer to the residue deposited on a medium, which is frequently a permeable medium, when a slurry, such as a drilling fluid, is forced against the medium under a pressure. Filter cake properties, such as cake thickness, toughness, slickness, and permeability, are important because the cake that forms on permeable regions of the wellbore can be beneficial to an operation or may be detrimental to an operation. The problems that a filter cake may present include reduced permeability during production and/or injection operations. In addition to the reduced efficiencies during the production/injection operations, the reduced permeability of a filter cake may also limit the ability of an operator to treat common problems during drilling operations, such as stuck pipe and lost returns. While filter cakes can present numerous challenges or disadvantages, operators also know that there are various advantages provided by filter cakes, such as limiting the loss of drilling fluid to the formation, reducing risks of contaminating or damaging a reservoir during drilling, retaining formation fluids during drilling to prevent kicks, etc. Accordingly, there has been a long history of publications and inventions directed to targeted creation and destruction of filter cakes. Exemplary teachings known in the art include the use of chelating agents to extract metallic weighting agents from filter cakes, the use of acidic treatment fluids to dissolve the filter cake elements, and/or the use of surfactants to clean the filter cake from the surface of the wellbore. Exemplary publications of such teachings may be found in U.S. Patent Publication No. 2008/0110621, which is incorporated herein in its entirety for all purposes. While this and other documents are incorporated herein in their entirety, the definition or usage of a term in this specification will control if there is any conflict between the definition or usage of a term in this specification and the specification of another patent document incorporated herein by reference. Other exemplary related publications may be found in U.S. Patent Publication Nos. 2007/0029085 and 2008/0110618; and in U.S. Pat. Nos. 5,909,774; 6,631,764; 7,134,496; and in Single-phase Microemulsion Technology for Cleaning Oil or Synthetic-Based Mud; Lirio Quintero, et al; 2007 AADE National Technical Conference, Apr. 10-12, 2007.

Filter cakes may be formed from aqueous and non-aqueous slurries. The properties of the filter cakes and the available remediation methods may vary depending on the type of slurry used when the filter cake forms. For example, it is well known that filter cakes formed from a non-aqueous fluid (NAF), such as an oil-based or synthetic oil-based drilling mud, exhibit far less permeability than a filter cake formed from an aqueous fluid and are also more difficult to remediate. While the decreased permeability of NAF filter cakes may suggest using aqueous drilling fluids to avoid the NAF filter cake, some implementations require NAF drilling fluids for a variety of reasons, as is well known. As one example, some implementations benefit from the decreased permeability during some stages of the drilling operation, but then need the NAF filter cake remediated after the drilling or as part of a lost returns treatment during the drilling operations. The decreased permeability of a NAF filter cake, or filter cake formed from NAF slurries, has been observed to complicate the remediation of the filter cake, often necessitating complex treatment fluids. In some proposed solutions, the NAF filter cake is only treatable by using a coordinated system of drilling muds and treating fluids. Other proposed solutions have attempted to use chelating agents to remove metallic weighting agents from the filter cake. While these solutions provide some improvement or some level of remediation, the conventional approaches are costly and complex. Accordingly, the need exists for systems and/or methods for remediating NAF filter cake, whether for the purpose of continuing drilling operations, such as in the event of lost returns, or for the purpose of improving production and/or injection operations.

### SUMMARY

The present disclosure is directed to fluids for use in hydrocarbon recovery operations, to methods of using such fluids, and to methods for conducting such hydrocarbon recovery operations. Exemplary fluids may be referred to as operations fluid and may comprise a non-aqueous fluid and at least one organo-anionic surfactant. The operations fluid may be adapted to perform as a treatment fluid for use during at least one of drilling operations, completion operations, production operations, and injection operations. For example, the treatment fluid may be adapted to reduce the elasticity of a NAF filter cake.

Exemplary organo-anionic surfactants that may be incorporated into the operations fluid may have the general formula: {R—X}⁻ ⁺{Y}. In some implementations, R is selected from the group comprising linear and branched alkyl and aryl alkyl hydrocarbon chains; X is an acid selected from the group comprising sulfonic acids, carboxylic acids, phosphoric acids, and mixtures thereof; and Y is an organic amine selected from the group comprising monoethanol amine, diethanol amine, triethanol amine, ethylene diamine, propylene diamine, diethylene tri-amine, tri-ethylene tetra-amine, tetra ethylene pent-amine, dipropylene tri-amine, tripropylene tetra-amine, tetra propylene pentamine, and mixtures thereof. For example, the organo-anionic surfactant may be selected from the group comprising monoethanol ammonium alkyl aromatic sulfonic acid, monoethanol ammonium alkyl carboxylic acid, and mixtures thereof.

Exemplary methods of utilizing the present operations fluids may include methods for remediating a NAF filter cake in a well. Such methods may include: 1) obtaining an operations fluid comprising an organo-anionic surfactant in a non-aqueous fluid; and 2) pumping a volume of the operations fluid into a well including a NAF filter cake, wherein the volume of operations fluid is pumped to contact the NAF filter cake. The NAF filter cake may be disposed on at least one of a fracture face, a sand screen, gravel pack components, and a wellbore wall. In some implementations, the remediation method may be applied during at least one of clean-up operations and workover operations to reduce an effective skin effect caused by the NAF filter cake.

Still additionally or alternatively, the present operations fluids may be used in hydrocarbon production operations. For example, some methods of using the operations fluids may include: 1) drilling through a formation using a NAF-based drilling fluid to form a well, wherein a NAF filter cake is formed on at least one component of the well; 2) treating the at least one component of the well with an operations fluid comprising an organo-anionic surfactant in a non-aqueous fluid to remediate the NAF filter cake; and 3) producing hydrocarbons through the well.

### BRIEF DESCRIPTION OF THE DRAWINGS

The foregoing and other advantages of the present technique may become apparent upon reading the following detailed description and upon reference to the drawings in which:

FIG. 1 is a schematic representation of a subsurface region and associated production system;

FIG. 2 is a schematic representation of a generalized organo-anionic surfactant;

FIG. 3 presents representations of three exemplary organic amines that may be used in preparing the present organo-anionic surfactants;

FIG. 4 presents representations of six exemplary acids that may be used in preparing the present organo-anionic surfactants;

FIG. 5 is a schematic flow chart of methods herein;

FIG. 6 is an additional schematic flow chart of methods herein;

FIG. 7 is an additional schematic flow chart of methods herein;

FIG. 8 is an additional schematic flow chart of methods herein;

FIG. 9 presents exemplary data regarding permeability of a NAF filter cake following various treatment options;

FIG. 10 illustrates a product cake following application of the present operations fluids; and

FIG. 11 illustrates a product cake following application of a conventional treatment fluid.

### DETAILED DESCRIPTION

In the following detailed description, specific aspects and features of the present invention are described in connection with several embodiments. However, to the extent that the following description is specific to a particular embodiment or a particular use of the present techniques, it is intended to be illustrative only and merely provides a concise description of exemplary embodiments. Moreover, in the event that a particular aspect or feature is described in connection with a particular embodiment, such aspects and features may be found and/or implemented with other embodiments of the present invention where appropriate. Accordingly, the invention is not limited to the specific embodiments described below. But rather, the invention includes all alternatives, modifications, and equivalents falling within the scope of the appended claims.

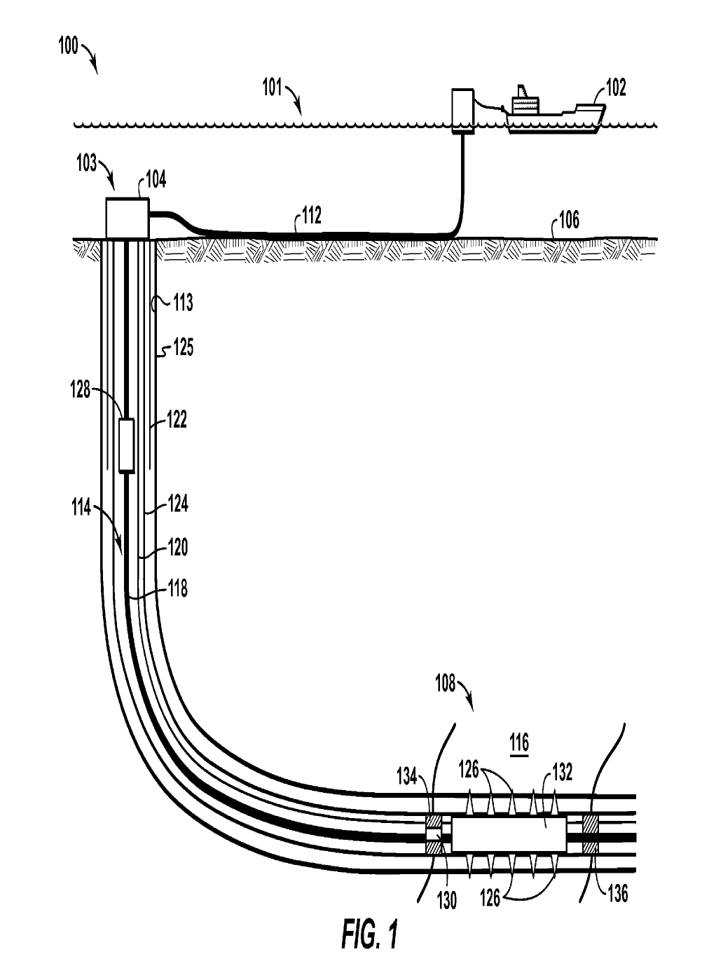

By way of background and to provide an illustrative, non-exclusive example of a subsurface region, a subsurface region 100 and an associated production system 101 is illustrated in FIG. 1. It should be noted that FIG. 1 and the other figures of the present disclosure are intended to present illustrative, but non-exclusive, examples according to the present disclosure and are not intended to limit the scope of the present disclosure. The figures may not be drawn to scale, as they have been presented to emphasize and illustrate various aspects of the present disclosure. In the figures, the same reference numerals designate like and corresponding, but not necessarily identical, elements through the various drawing figures.

In production system 101, a floating production facility 102 is coupled to a well 103 having a subsea tree 104 located on the sea floor 106. To access subsea tree 104, a control umbilical 112 may provide a fluid flow path between subsea tree 104 and floating production facility 102 with a control cable for communicating with various devices within well 103. Through subsea tree 104, floating production facility 102 accesses a subsurface formation 108 that includes hydrocarbons, such as oil and gas. Offshore production system 101 is shown for illustrative, non-exclusive purposes, and the present compositions and methods may be used in connection with the injection, extraction, and/or production of fluids into or from reservoirs or other formations at any subsurface location.

To access subsurface formation 108, well 103 penetrates sea floor 106 to form a wellbore 113 bounding a well annulus 114 that extends to and through at least a portion of subsurface formation 108. Subsurface formation 108 may include various layers of rock that may or may not include hydrocarbons and may be referred to as zones. In this example, subsurface formation 108 includes a production zone, or interval, 116. This production zone 116 may include fluids, such as water, oil, and/or gas. Subsea tree 104, which is positioned over well annulus 114 at sea floor 106, provides an interface between devices within well annulus 114 and floating production facility 102. Accordingly, subsea tree 104 may be coupled to a production tubing string 118 to provide fluid flow paths and to a control cable 120 to provide communication paths, which may interface with control umbilical 112 at subsea tree 104.

Well annulus 114 also may include various casings, or casing strings, 122 and 124 to provide support and stability for access to subsurface formation 108. For example, a surface casing string 122 may be installed from sea floor 106 to a location beneath sea floor 106. Within surface casing string 122, an intermediate or production casing string 124 may be utilized to provide support for the walls of well annulus 114. Production casing string 124 may extend down to a depth near or through subsurface formation 108. If production casing string 124 extends to production zone 116, then perforations 126 may be created through production casing string 124 to allow fluids to flow into well annulus 114. Further, surface and production casing strings 122 and 124 may be cemented into a fixed position by a cement sheath or lining 125 within well annulus 114 to provide stability for well 103 and to isolate subsurface formation 108. Still alternatively, a portion of the well 103 may be left as an open hole with an exposed wellbore, or formation face.

As such a well is being drilled, there are lengths of formation exposed by the ongoing drilling operation. It is not uncommon for a fracture to form in the wellbore exposing large surface areas of the formation and allowing the returning drilling mud to escape from the well annulus. When these events occur, the volume of drilling mud entering the fracture and the formation can be large and can result in numerous problems in the drilling operation. Such volumes of drilling mud are generally referred to as lost returns; the issues or complexities raised by lost returns are well documented. Once a fracture has opened, the lost returns problem can only be stopped by arresting the expansion of the fracture. Various methods have been disclosed for arresting this expansion, including methods referred to as Fracture Closure Stress (FCS) methods and Drill Stress Fluid (DSF) methods, each of which depend at least in part on the permeability of the fracture surface for their successful implementation. As described above, when the drilling mud is a NAF-based slurry the permeability of the fracture surfaces can be dramatically reduced by the NAF filter cake, which can dramatically reduce the effectiveness of the FCS and/or DSF methods. The present compositions and methods may be useful in remediating the NAF filter cake, thereby increasing the effectiveness of the FCS and/or DSF methods. The FCS method and the DSF method are both described in part herein and are more thoroughly described in International Publication No. WO 2009/014585 A1, which is incorporated herein by reference in its entirety for all purposes.

To produce hydrocarbons from production zone 116, various devices may be utilized to provide flow control and isolation between different portions of well annulus 114. For instance, a subsurface safety valve 128 may be utilized to block the flow of fluids from production tubing string 118 in the event of a rupture or break in control cable 120 or control umbilical 112 above subsurface safety valve 128. Further, a flow control valve 130 may be utilized and may be or may include a valve that regulates the flow of fluid through well annulus 114 at specific locations. Also, a tool 132 may include a sand screen, flow control valve, gravel packed tool, or other similar well completion device that is utilized to manage the flow of fluids from production zone 116 through perforations 126. Packers 134 and 136 may be utilized to isolate specific zones, such as production zone 116, within well annulus 114.

Whenever a NAF-based slurry is flowed through the borehole, there is the risk of a NAF filter cake forming on one or more of these various pieces of downhole equipment. While some equipment may be relatively unaffected by the filter cake accumulation, the downhole conditions and operations are typically quite confined and accumulations of filter cake may be undesirable. Moreover, many types of downhole completion equipment can be negatively impacted by the filter cake accumulation. For example, screens, gravel packs, perforations, and other completion features and equipment through which fluids are supposed to flow may be negatively impacted by an accumulation of filter cake, particularly when the filter cake is a NAF filter cake having reduced permeability. The present compositions and methods are believed to be useful in remediating a NAF filter cake that may be accumulated on completion equipment or other downhole equipment, features, or surfaces. As one example of an extension to a downhole surface that would not conventionally be considered ‘completion equipment,’ the present compositions and methods may be used to remediate a NAF filter cake accumulated on an open hole wellbore face. Additionally or alternatively, the present compositions and methods are believed to be useful in altering the properties of the NAF filter cake to improve the hydrocarbon recovery operations.

It can be understood that the present disclosure provides compositions comprising organo-anionic surfactants for use in hydrocarbon recovery operations. Surfactants, in the generalized sense of the term, are well known and have been used in hydrocarbon recovery operations for a variety of purposes. While surfactants, generally, have been used for purposes including remediation of filter cake on downhole equipment, a review of the conventional compositions and methods reveals the conventional wisdom of such remediation methods: filter cake remediation requires the use of either a strong acid or a strong base. The use of a strong acid provides the foundation for acid-based remediation efforts, using fluids such as sulfuric acid. The use of strong bases, such as in the form of cationic surfactants, zwitterionic surfactants, and/or alkali-metal-based surfactants, form the foundation for conventional surfactant-based remediation efforts. When using a conventional surfactant, such as those formed from a strong base and a weak acid (i.e., a strong/weak surfactant), the remediation fluids typically require a co-solvent, such as alcohols, to improve the solubility of the strong/weak surfactant, particularly in high salinity slurries or muds. The use of a co-solvent increases the cost of the slurry, increases the complexity of the fluid make-up, and requires additional clean-up efforts. Additionally, many of the conventional, strong/weak anionic surfactants required the use of a co-surfactant, such as a non-ionic surfactant or a cationic surfactant, to form a micro-emulsion or nano-emulsion. Here again, the use of a co-surfactant increases costs, complexity, and clean-up requirements.

The conventional wisdom of surfactant-based remediation compositions and methods is analogous to cleaning methods in other fields where it is generally accepted that a strong base cleans better than a weak base and that a surfactant incorporating a strong base will be most effective at cleaning. The organo-anionic surfactants of the present compositions and methods are formed by a weak base and a weak acid, forming what can be referred to as a weak/weak surfactant or, in the terms of the present disclosure, an organo-anionic surfactant. The use of a weak base as the building block for a filter cake remediation fluid is counter-intuitive based upon the prior literature and conventional technology, but has been found to be effective as a remediation fluid, as will be seen herein.

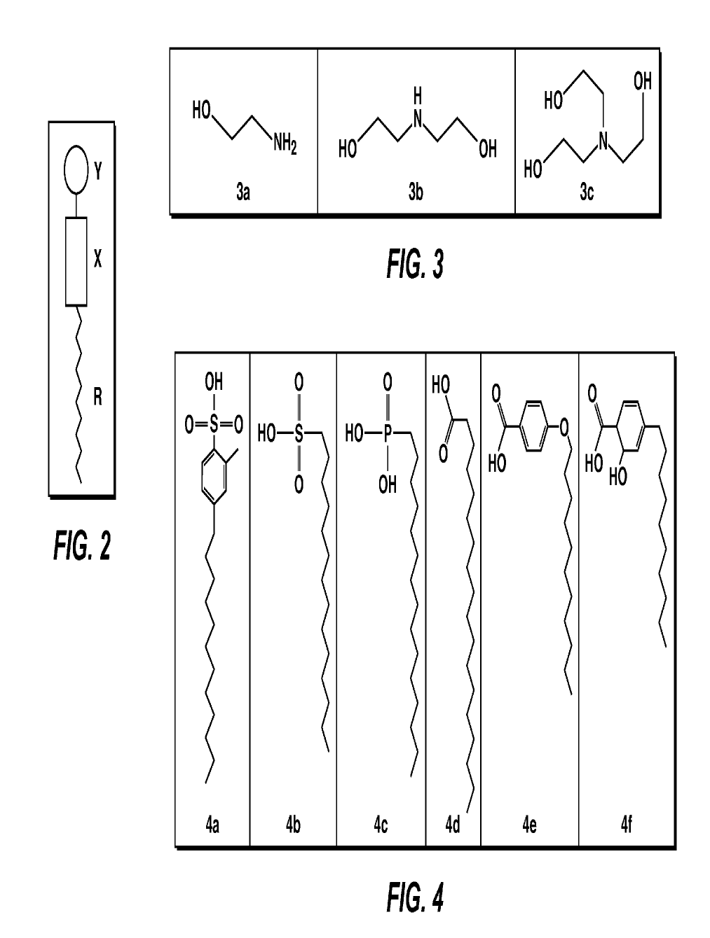

The general chemical structure of the present organo-anionic surfactants is given by the formula: {R—X}⁻ ⁺{Y}, which is generally illustrated in FIG. 2. In the illustration of FIG. 2, R is selected from the group comprising linear and branched alkyl and aryl alkyl hydrocarbon chains, X represents an acid selected from the group comprising sulfonic acids, carboxylic acids, phosphoric acids, and mixtures thereof, and Y represents a weak organic base, such as an organic amine.

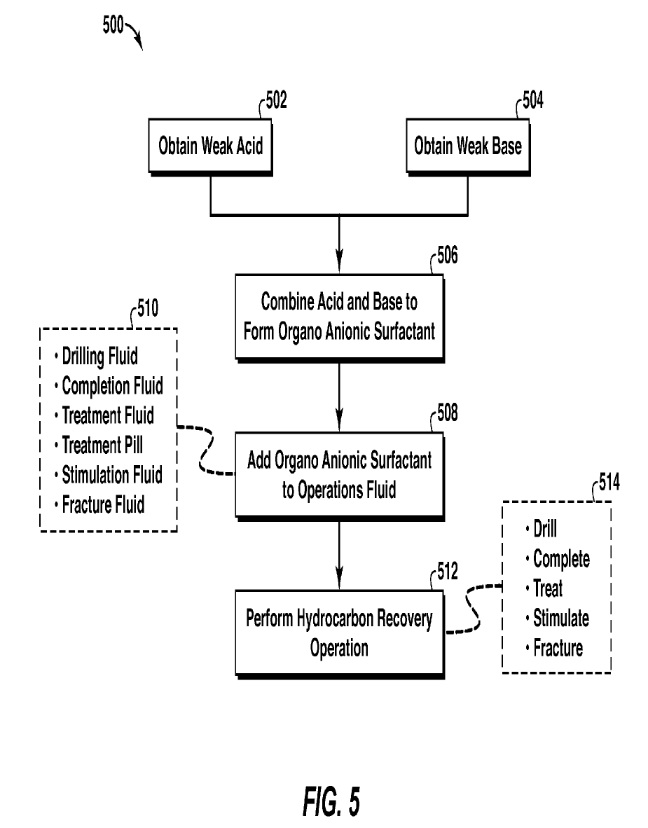

While a variety of weak organic bases may be used in the present compositions and methods, organic amines may be preferred. Exemplary organic amines include monoethanol amine, diethanol amine, triethanol amine, ethylene diamine, propylene diamine, diethylene tri-amine, tri-ethylene tetra-amine, tetra ethylene pent-amine, dipropylene tri-amine, tripropylene tetra-amine, tetra propylene pentamine, and mixtures thereof. Preferably, the organic amine may be monoethanol amine, diethanol amine, triethanol amine, and mixtures thereof, such as illustrated in FIG. 3a-3c. More preferably, the organic amine is monoethanol amine. Exemplary weak acids are illustrated in FIGS. 4a-4f, which illustrates exemplary weak acids together with exemplary associated R groups. The acid may be an organic acid, such as alkyl acids, alkyl aromatic acids and mixtures thereof. Further, exemplary organic acids may include alkyl carboxylic acids, aromatic carboxylic acids, alkyl sulfonic acids, aromatic sulfonic acids, alkyl phosphoric acids, aromatic phosphoric acids and mixtures thereof. A simple combination of the organic amines of FIG. 3 with the weak acids of FIG. 4 illustrates a representative family of eighteen organo-anionic surfactants within the scope of the present disclosure. Based on the representative acids and bases described here, the number of available organo-anionic surfactants is potentially very large. While a variety of organo-anionic surfactants are within the scope of the present disclosure, they all have one feature in common. The organo-anionic surfactants of the present disclosure comprise an anionic acid whose counter ion is a mono-, di-, or tri-ethanol ammonium cation.

Organo-anionic surfactants of the instant invention are prepared by contacting a weak acid, such as an organic acid or other acid described above, with a weak base, such as an organic amine or other base described above. Contacting can be done at any temperature preferably in the range of −50° C. to 200° C. The preferred temperature range for the acid-base reaction will depend on the choice of weak acid and weak base. The amount of base that is used in the reaction may be equal to the molar equivalent of the weak or organic acid or may be less than the molar equivalent of the weak or organic acid. As an illustration, if the weak acid is an organic acid of molecular weight 200 and the weak base is of molecular weight 100, then in the case of molar equivalent, the weight ratio of base: acid is 2:1. In the case of less than the molar equivalent, the weight ratio of base: acid is <2:1, for example 1.5:1, 1.25:1, 1:1, 0.75:1, 0.5:1 and so on. The organo-anionic surfactant is formed by contacting the weak base with the weak acid. In some implementations, the organo-anionic surfactant may be formed by contacting a neat base with a neat acid. The resulting organo-anionic surfactant may then be incorporated into an aqueous fluid and/or a non-aqueous fluid. Additionally or alternatively, in some implementations, each of the weak base and the weak base may be dissolved in separate aqueous solutions that are then mixed to contact the base and the acid to form the organo-anionic surfactant in an aqueous solution. The aqueous solution of formation may then be incorporated into other aqueous fluids and/or non-aqueous fluids for use in hydrocarbon recovery operations.

The present disclosure provides a fluid for use in hydrocarbon recovery operations, such as on wells associated with hydrocarbon production. The fluid may be aqueous fluids or non-aqueous fluids. The aqueous fluids comprise water and at least one organo-anionic surfactant. The aqueous fluid may be incorporated into a variety of stages of the hydrocarbon recovery operations and may be incorporated into a variety of slurries, muds, fluids, etc. (e.g., including non-aqueous slurries). For example, the aqueous fluid may be incorporated into drilling fluid, treatment fluid, injection fluid, treatment pills, etc. Similarly, the non-aqueous fluids described herein comprise a non-aqueous fluid and at least one organo-anionic surfactant. The non-aqueous fluids incorporating the organo-anionic surfactant(s) may be used in a variety of fluids and slurries and may be used in a variety of operations. Non-aqueous fluids incorporating the present organo-anionic surfactants may incorporate the neat surfactant and/or may incorporate an aqueous solution of the surfactant, such as by emulsification and/or micro-emulsification. For clarity and ease of reference herein, fluids incorporating organo-anionic surfactants will be referred to generally as operations fluids regardless of the type of operation in which the fluid will be used or the type of fluid being use (e.g., aqueous, non-aqueous).

The organo-anionic surfactants of the present disclosure can be incorporated into aqueous solutions and/or into any variety of slurries, muds, or fluids that may be used in hydrocarbon recovery operations. FIG. 5 illustrates a simplified flow chart of methods 500 within the scope of the present disclosure. As illustrated, the methods 500 may begin by obtaining a weak acid 502 and obtaining a weak base 504. As can be understood from the discussion above, the acid and the base can be obtained at the same time or in any suitable order, as suggested by their positions in the flowchart of methods 500. As illustrated in FIG. 5, the methods continue by combining the acid and the base to form the organo-anionic surfactant at step 506. The organo-anionic surfactant is then added to an operations fluid at step 508. As discussed above, the organo-anionic surfactant may be added to virtually any type of fluid used in hydrocarbon recovery operations. Exemplary, non-exhaustive, fluid types to which the organo-anionic surfactants may be added are listed in box 510. The methods 500 continue at 512 by performing at least one hydrocarbon recovery operation with the operations fluid. Box 514 provides illustrative, non-exhaustive examples of operations that may be performed using the operations fluids of the present disclosure (i.e., fluids comprising organo-anionic surfactants).

The ratio of organo-anionic surfactant in the operations fluid may vary depending on the application of the operations fluid and the stage in which it is being used in the hydrocarbon recovery operations. For example, when the operations fluid is a drilling fluid, the organo-anionic surfactant may comprise greater than about 0.5 wt % and less than about 50 wt %, based on the combined weight of the drilling fluid. In other examples, such as when the operations fluid is an injection fluid or a treatment fluid, the composition of the operations fluid may vary over time, such as having a greater percentage of the present organo-anionic surfactants early in the operation stage and decreasing over time. As described herein, the present organo-anionic surfactants have the advantage of altering the properties of the NAF filter cake, such as by remediating the NAF filter cake to improve or restore permeability. As such, the organo-anionic surfactant(s) may constitute a larger percentage of the operations fluid initially to change the permeability (or otherwise modify the NAF filter cake) and then constitute a smaller percentage while the other components of the operations fluid are performing their functions, such as isolating the fracture to prevent lost returns.

As described above, the operations fluid may comprise an organo-anionic surfactant and water or mixtures of organo-anionic surfactants and water. The concentration of the organo-anionic surfactant may be greater than about 0.01 wt % and less than about 12 wt %, based on the weight of water. Preferably, the concentration of the organo-anionic surfactant may be greater than about 0.01 wt % and less than about 5 wt %, and more preferably the concentration may be greater than about 0.01 wt % and less than about 2 wt %. Any of the organo-anionic surfactants described herein may be used. Preferably, the organo-anionic surfactant is selected from a monoethanol ammonium alkyl aromatic sulfonic acid, monoethanol ammonium alkyl carboxylic acid and mixtures thereof. The surfactants incorporated into the operations fluid may incorporate different alkyl groups. The surfactants may incorporate alkyl groups having a variety of chain lengths or a variety of numbers of carbon atoms, such as greater than about 6 carbon atoms and less than about 18 carbon atoms. Preferably, the alkyl groups may have chain lengths greater than about 9 carbon atoms and less about 14 carbon atoms. More preferably, the alkyl groups may be a mixture having greater than about 10 carbon atoms and less than about 14 carbon atoms. Most preferably, the mixture has at least 50% of the surfactant comprising 12 carbon atoms on the alkyl groups.

Preferably, the number of carbon atoms on the alkyl group of the organo-anionic surfactant is equal to the average number of carbon atoms per molecule of the non-aqueous drilling fluid being targeted by the surfactant. For example, if the non-aqueous drilling fluid that formed, or is expected to form, the NAF filter cake is comprised primarily of molecules having 12 carbons, such as dodecane, then preferably the organo-anionic surfactant or mixture of organo-anionic surfactants has an alkyl chain with an average carbon chain length of 12. For example, a combination of surfactants having alkyl chain lengths including lengths of 11, 12, and 13 could be combined for an average chain length of 12. When the organo-anionic surfactant and/or the combination of organo-anionic surfactants, has an average alkyl chain length corresponding to the chain length of the corresponding NAF fluid, it is referred to herein as “alkyl chain matched.” Without being bound by theory, it is presently believed that an alkyl chain matched organo-anionic surfactant and/or an alkyl chain matched mixture of organo ionic surfactants may be preferred in treating or otherwise remediating the NAF filter cakes. Such alkyl chain matched surfactants have unique and unexpected performance advantages such as very low concentration requirements to attain high performance.

The operations fluid including the organo-anionic surfactant(s) may further comprise dissolved salts, such as chloride and sulfate salts of calcium and potassium. For example, when the operations fluid is an aqueous fluid comprising organo-anionic surfactants, the aqueous fluid may contain a variety of additives common to aqueous fluids used in hydrocarbon recovery operations; dissolved salts is but one example. The amount of dissolved salts, when included, may be greater than about 0.01 wt % and less than about 25 wt %, based on the weight of water. Preferably, greater than about 0.01 wt % and less than about 5 wt %. The operations fluid may further comprise alcohols such as methanol, ethanol, propanol, butanol, pentanol, hexanol, heptanol, octanol and mixtures thereof. The alcohols, when included, may be greater than about 0.001 wt % and less than about 15 wt %, based on the weight of water. As discussed above, the compositions of the present disclosure, in contrast to the conventional surfactants, do not require alcohols. Still additionally or alternatively, the aqueous fluid including the organo-anionic surfactant(s) may further comprise organic acids, such as greater than about 0.001 wt % and less than about 6 wt %, based on the weight of water. Preferably, greater than about 001 wt % and less than about 3 wt %, based on the weight of water.

Without limiting the generality of the description above or the scope of the claimed invention herein, illustrative examples of hydrocarbon recovery operations and associated operations fluids comprising organo-anionic surfactants are described herein to further illustrate the utility and applicability of the present technology. In illustrative examples, the organo-anionic surfactant may be added to aqueous and/or non-aqueous fluid(s) to improve drilling operations, completion operations, clean-up operations, production operations, injection operations, and/or treatment operations. While exemplary compositions, operations, advantages, and functionality are described for both non-aqueous fluids comprising organo-anionic surfactant(s) and aqueous fluids comprising organo-anionic surfactants, the operations, advantages, and functionality of any specific composition (e.g., non-aqueous and/or aqueous compositions) may be common to other compositions described herein. For example, all of the compositions described herein are believed to provide one or more of the following advantages by virtue of incorporating the organo-anionic surfactant(s): 1) the oil uptake effectiveness and efficiency of the fluids comprising organo-anionic surfactant(s) is higher than comparable fluids comprising alkali metal anionics for a given concentration and salinity; 2) the organo-anionic surfactants provide formulation flexibility and cost advantages and can be formulated over a wider range of water salinity; and 3) the organo-anionic surfactant(s) can be formulated into hydrocarbon recovery fluids with a single family of surfactants, such as not requiring the use of additional non-ionic co-surfactants or co-solvents. Additionally or alternatively, when the organo-anionic surfactants are incorporated into operations fluids that are applied to treat existing NAF filter cakes, it is observed that the existing NAF filter cake may change from oil wetting to water wetting, and, when the operations fluid is an aqueous fluid, the operations fluids may extract non-aqueous fluid from the NAF filter cake. Either or both of these functions may remediate the NAF filter cake to changes its properties, such as its permeability, its elasticity, etc. Other advantages, features, and functionality described herein in the context of one or more exemplary compositions may be found in other compositions described or claimed herein.

One exemplary use of the organo-anionic surfactants may be in the treatment of lost returns problems, such as in conjunction with FCS and/or DFS methods. In such implementations, the organo-anionic surfactant may be incorporated into a treatment pill that is pumped prior to the delivery or pumping of the FCS pill, may be incorporated into a treatment pill that is pumped during the DFS methods, and/or may be incorporated directly into the fluids that comprise the FCS pill or treatment fluids. As explained in prior publications regarding the FCS methodology and the DFS methodology, these methods of treating lost returns depend in part on the permeability of the fracture faces and the ability of the carrier fluids to leak off quickly to trap the FCS solids in the fracture. As can be understood from the foregoing, the presence of the organo-anionic surfactant in the NAF composition of a drilling operation, such as a DSF drilling operation, will result in a NAF filter cake having improved permeability rendering the DSF methods more effective.

Additionally or alternatively, it has been found that application of an operations fluid containing organo-anionic surfactants to an existing NAF filter cake is effective at remediating the NAF filter cake, such as restoring permeability, reducing elasticity, changing wettability, and facilitating the clean up and/or removal of the filter cake, such as from the formation and/or the completion equipment. In some exemplary implementations, the NAF filter cake may be disposed on at least one of a facture face, a sand screen, gravel pack components, and a wellbore wall. The volume of operations fluid containing organo-anionic surfactants may be pumped downhole to contact these features and to breakup or otherwise remediate the NAF filter cake. As seen in the illustrative examples that follow, a relatively small amount of operations fluid containing organo-anionic surfactants may be effective in treating or remediating the filter cake. Depending on the nature of the implementation, the volume of operations fluid and the concentration of organo-anionic surfactants incorporated therein may vary. Exemplary concentrations of the organo-anionic surfactant in the aqueous portion of the operations fluid may be as described above. In contrast, when incorporated into a treatment pill adapted to remediate sand control equipment in an extended open hole section of the well, the volume of operations fluid may significantly increase. Engineers designing the operations will recognize that the volume of operations fluid required to remediate the NAF filter cake may depend on factors such as the location of the filter cake, the nature of the filter cake, the extent of filter cake needed to remediate, the permeability of the formation, the likelihood of thief zones, etc. Accordingly, while a specific volume of operations fluid may be definable for a given implementation, the present methods are best understood as applying or pumping a volume of operations fluid comprising organo-anionic surfactants into the well to remediate or treat the NAF filter cake.

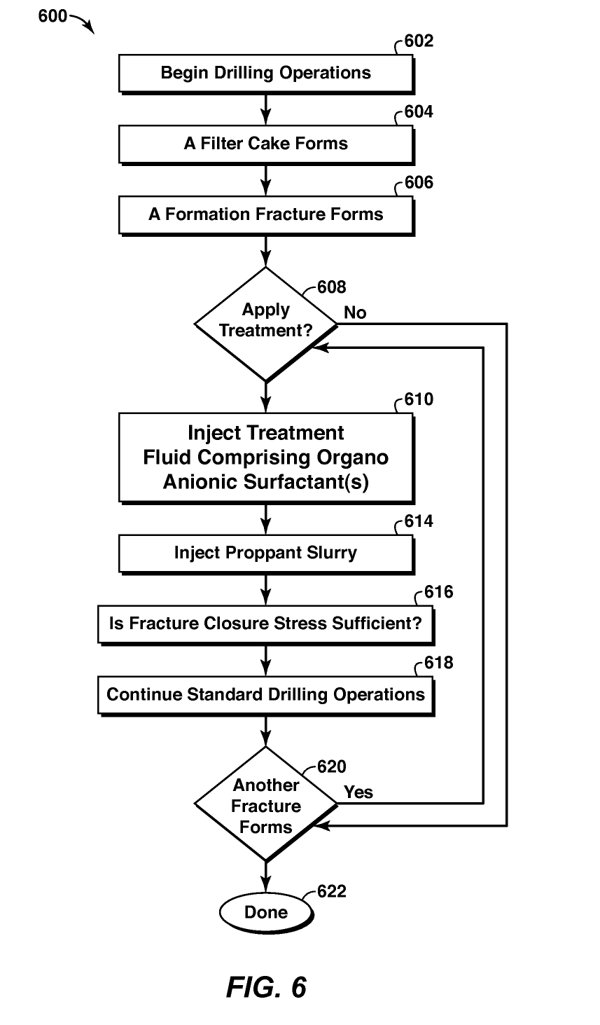

As one illustrative implementation, aqueous treatment fluids comprising the present organo-anionic surfactants may be used as an operations fluid in an FCS-based lost returns treatment. FIG. 6 is an exemplary flow chart of methods 600 of treating lost returns in a well including a fracture. As depicted in the flow chart, an operator is engaging in drilling operations 602 and forming a filter cake 604 when a fracture forms in the wellbore 606. It is worth noting that the filter cake forms on the wellbore wall and on the face of the fracture. The operator may then determine whether treatment is needed, at 608, such as if there is a lost returns problem. If treatment is needed or desired, the operator may begin the treatment by injecting, as illustrated at box 610, an aqueous treatment fluid comprising organo-anionic surfactant(s), as described herein, before continuing the drilling operations, at 618. The treatment process includes injecting proppants, at 614, into the fracture while leaking off carrier fluids to deposit FCS proppants in the facture and while increasing the circulating pressure in the wellbore above the fracture pressure. The pressure may be increased to increase the fracture closure stress, or the integrity, of the formation. When the fracture closure stress is sufficiently elevated, at 616, the drilling operations may continue, such as at 618. In the event that another fracture forms, illustrated at 620, the process may continue by returning to determining whether another treatment should be applied, as at 608. This method continues until the well is drilled to the desired depth.

Additionally or alternatively, some methods of utilizing the present fluids comprising organo-anionic surfactants may proactively prevent lost returns by intentionally fracturing the wellbore at strategic times to apply an FCS process, or other suitable process to increase the integrity of the formation. The strategic, intentional formation of a fracture may allow the operator to better time the treatment operations to avoid substantial lost returns and/or to utilize the treatment equipment and fluids on a preferred schedule rather than in response to unexpected lost returns incidents.

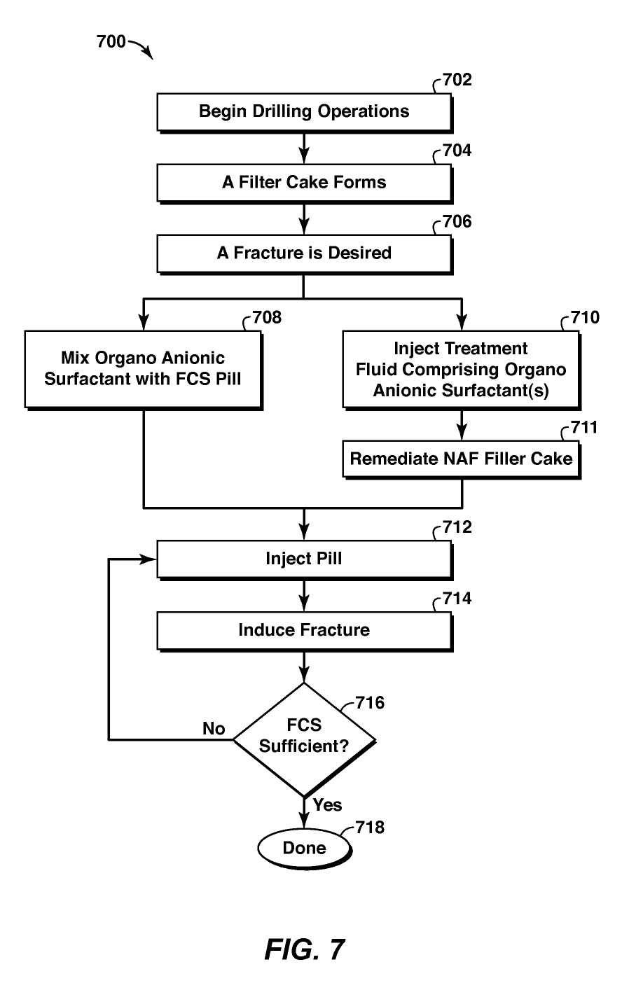

FIG. 7 is an exemplary flow chart of methods 700 for strategically applying FCS treatments utilizing organo-anionic surfactants. As illustrated, the drilling operations begin at 702 and a filter cake forms at 704, such as would occur when drilling with a NAF drilling fluid. A fracture may be desired, at 706, for a variety of reasons, such as to intentionally apply an FCS process to increase the integrity of the wellbore. Once the operator recognizes that a fracture is desired, the present technology provides at least two options, as illustrated in FIG. 7. For example, the operator may mix organo-anionic surfactants with an FCS pill, at 708, or the operator may treat the wellbore, or a targeted section of the wellbore, with an aqueous treatment fluid comprising organo-anionic surfactant(s), at 710, to remediate the NAF filter cake, at 711. An operator may then inject the FCS pill into the wellbore at 712. The injection of the FCS pill may be conducted so as to induce a fracture, as at 714, into which an immobile mass is deposited, such as from the solids or particulates in the FCS pill. The methods 700, similar to conventional FCS methods, may increase the circulating pressure in the wellbore to increase the FCS of the formation or wellbore until the FCS is sufficient to continue drilling, at 716. In some implementations, it may be preferred to induce the fracture before injecting the FCS pill. For example, the injection of the FCS pill 708 and/or the remediation of the NAF filter cake 711 may increase the permeability of the formation sufficiently to make it more difficult to induce a fracture.

Some utilizations of the present organo-anionic surfactants and fluids containing the same may also be adapted to address problems associated with differential pressure sticking (DPS). Filter cakes formed in a well, whether NAF-based or otherwise, may cause the well tool or pipe to “stick” in the wellbore. The NAF filter cakes are less likely to encounter this problem, but it may still occur. The organo-anionic surfactants of the present disclosure may be utilized to remediate the NAF filter cake, decreasing its volume and/or increasing its permeability to free a differentially stuck pipe or well tool. As seen in the examples herein, the organo-anionic surfactants of the present disclosure are effective at both breaking up the NAF filter cake and increasing the permeability of the filter cake.

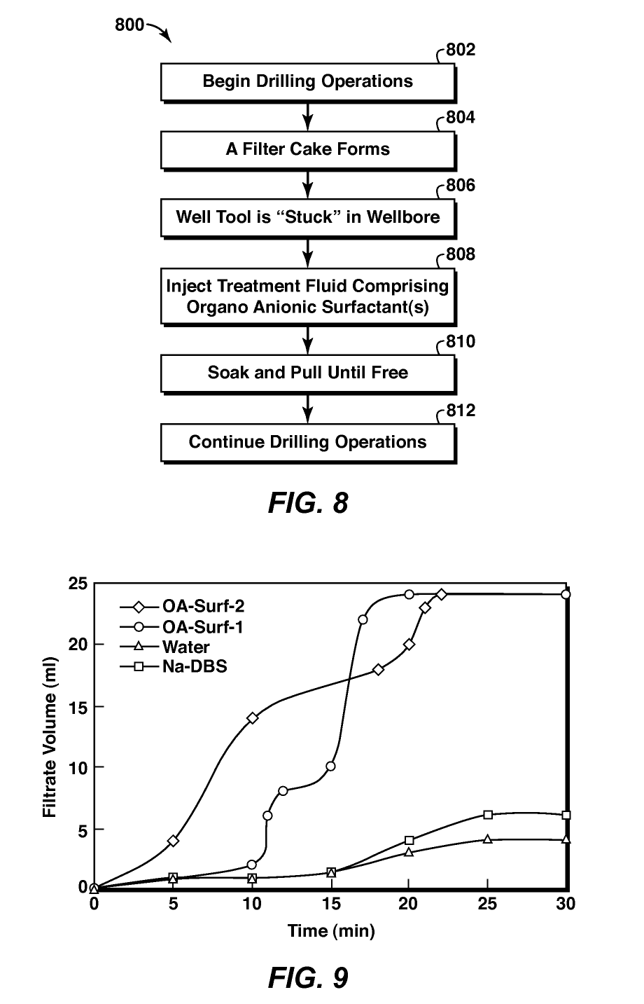

FIG. 8 is an exemplary flow chart of preferred methods 800 of treating differential pressure sticking of a well tool. As depicted in the flow chart, the operator may be conducting drilling operations 802, thereby forming a filter cake 804 in the well such that the well tool is stuck 806 by differential pressure sticking. The operator may then inject, at 808, a treatment fluid comprising organo-anionic surfactant(s) to increase the filter cake permeability and/or break up the filter cake. The operator may allow the treatment fluid to soak for a time before pulling or moving the tool until free, at 810. Once the tool is free, the drilling operations (or other operations) may be continued as planned, at 812. The period of time required for the soak may vary depending on the nature and extent of the filter cake, the degree to which the tool is stuck, the quantity and concentration of treatment fluid used, etc. Additionally or alternatively, the operator may periodically attempt to manipulate the pipe or tool to free it without a predetermined soak period.

While the present disclosure may be understood as an organo-anionic surfactant in an aqueous fluid that forms part of an operations fluid, the present disclosure may also be understood as being directed to an organo-anionic surfactant incorporated into a non-aqueous fluid for use in hydrocarbon recovery operations, such as in a NAF-based drilling fluid, a NAF-based treatment fluid, a NAF-based completion fluid, etc. When incorporated into a NAF-based fluid, the concentration of the organo-anionic surfactant in the NAF composition may be greater than about 0.01 wt % and less than about 30 wt %, based on the weight of non-aqueous fluid in the NAF composition. Preferably, greater than about 0.01 wt % and less than about 5 wt % and more preferably greater than about 0.01 wt % and less than about 2 wt %.

The NAF composition may be any suitable composition, such as those compositions that are conventionally used in hydrocarbon recovery operations. Exemplary non-aqueous fluids into which the organo-anionic surfactants may be incorporated may comprise linear, branched, or cyclic alkanes; linear alpha olefins, branched olefins, cyclic olefins; esters synthesized from linear, branched, or cyclic alkane acids; and linear, branched, or cyclic alcohols; mineral oil hydrocarbons; bioesters, such as but not limited to glyceride mono-, di-, and tri-esters, derived from plants and animals, including olive, coconut, canola, castor, corn, cotton seed, rapeseed, lard, and soybean oils and mixtures and combinations thereof. The NAF composition may further comprise, in addition to the organo-anionic surfactant, one or more of: at least one emulsifier, at least one weighting agent, at least one rheology modifier, at least one filtration control agent, and/or other conventional additives to NAF compositions that are common in hydrocarbon recovery fluids.

The composition and relative amounts of each component may vary between the various applications of NAF compositions in which the present organo-anionic surfactants may be incorporated. Moreover, the manner in which the organo-anionic surfactant is incorporated in the NAF composition may vary. For example, a neat surfactant, made from contacting a neat acid and a neat base, may be mixed directly in the non-aqueous fluid. Additionally or alternatively, the organo-anionic surfactant may be incorporated into an aqueous fluid that is then incorporated into the non-aqueous fluid, such as by emulsification and/or micro-emulsification. When the organo-anionic surfactant(s) are in an aqueous fluid that is incorporated into a non-aqueous fluid, the aqueous fluid may be according to any of the description herein of aqueous fluids comprising organo-anionic surfactants. The amount of aqueous solution incorporated into the non-aqueous fluid may be limited by emulsification principles and the intended utility and final composition of the non-aqueous fluid. When the neat organo-anionic surfactant(s) are incorporated into a non-aqueous fluid directly, the organo-anionic surfactant(s) may comprise greater than about 0.01 wt % and less than about 20 wt % based on the weight of the non-aqueous fluid. Preferably, greater than about 0.01 wt % and less than about 10 wt %.

Without being bound by theory, it is presently believed that the organo-anionic surfactant(s) disclosed herein imparts one or more unique properties to the non-aqueous fluid composition. One such property is that the NAF composition forms NAF filter cakes of low elasticity. Having the ability to control filter cake elasticity has advantages in many reservoir processes such as but not limited to (i) improved well bore clean up, (ii) improved injectivity, and (iii) remediating damage to gravel pack and screen productivity.

Using improved wellbore clean up as a first example, the organo-anionic surfactants are believed to facilitate the removal of filter cake as a well is transitioned from drilling and completions mode to production mode. During a drilling operation or other operation where NAF compositions are pumped into a well, the NAF composition invades the pore spaces adjacent to the borehole and deposits material to form “internal filter cake.” It also deposits material on the surface of the borehole to form “external filter cake.” Herein after the term “filter cake” will include both the internal and external filter cake, except where specifically indicated otherwise. The depth of invasion and character of the filter cake formed depend on a variety of factors, including the components of the NAF compositions, the size of the pore throats relative to the mud solids, the differential pressure driving the flow, the effectiveness of the filter cake deposited on the face of the borehole, and any ionic or surface tension interaction between the fluid and pore channels. When the well is put on production, the filter cake is expected to lift off, such as by the flow of formation fluids into the wellbore or by the action of a treatment fluid. In the context of a treatment fluid, many of the treatment fluids desirably used are aqueous fluids. A NAF filter cake that is oil wetting is generally not well treated by aqueous treatment fluids. However, as indicated above, the present organo-anionic surfactants may change the wettability of a NAF filter cake from oil wetting to water wetting rendering conventional clean-up treatment fluids more effective.

It has been observed that NAF filter cakes exhibit elasticity due to the interactions between the solids and the oils. Additionally, it has been observed that elastic filter cakes resist movement through the rock. If the elastic resistance is high, the filter cake remains in place and production rates (or other operations) are adversely impacted. This elastic effect further compounds the negative effects of filter cake during production operations. The effects of filter cake on a formation are often referred to as “skin.” A grade of 0 indicates there is no damage or limitation and production rates are as expected. In wells drilled with NAF, the skin typically grades in the range of 1-3, so there is quantifiable evidence (such as by observed poor production rates) that remediation is needed. The degree to which this damage or skin occurs can be reduced by drilling with the NAF of the present disclosure incorporating organo-anionic surfactants. The disclosed NAF compositions form filter cakes of low elasticity allowing the internal filter cakes to flow easily back to the wellbore during treatment with a wellbore cleanup solution or during production operations. As discussed elsewhere herein, the present organo-anionic surfactants may be incorporated into operations fluid for altering the properties of the filter cake being formed and/or to treat existing filter cakes. Accordingly, treatment fluids incorporating the organo-anionic surfactants described herein may be applied as a pre-treatment or concurrently with the conventional wellbore clean-up fluids

As another example of suitable implementations utilizing a NAF operations fluid including organo-anionic surfactants, the organo-anionic surfactants may improve injection operations. It will be understood that the effectiveness of an injection operation depends on the ability of the injected fluid to pass through the formation face and through the pores of the formation. As discussed above, these same pores may be plugged by NAF filter cakes. When a NAF composition incorporating organo-anionic surfactant(s) is used as the drilling fluid or other hydrocarbon recovery fluid that forms the filter cake, the resulting NAF filter cake will have a controlled or reduced elasticity, such as described above. Elastic NAF filter cakes reduce the injectivity of the injected fluids in much the same way the elastic NAF filter cake reduces the productivity of formation fluids, by limiting the mobility of the solids that form the filter cake. During injection, the flow must occur through both the external NAF filter cake on the borehole wall, as well as the internal elastic NAF filter cake in the pore spaces. Limited injection rates will result. Due to the limited number of disposal wells available and/or the specific needs for injection in stimulation treatments, the limited injection rates in regions of the well where injection is needed may have dramatic consequences for the well and/or field. For example, an injection well intended to introduce fluids to move hydrocarbons towards a production well may be rendered useless (for its intended purpose) if the injectivity of the well, or of a segment of the well, is sufficiently limited. A variety of injectivity enhancement treatments are available to address this issue. However, it is common for the higher permeability, or lower skin, region of the well to clean up while other areas, such as those covered in an elastic NAF filter cake, remain untreated because the pressure drop required to force the treatment into those regions is lost. When the purpose of injection is for reservoir pressure maintenance or secondary recovery, the consequences are significant. Some sections may receive fluid and others not, affecting the production profile from the entire reservoir. The degree to which injectivity damage, such as that caused by the presence of an elastic NAF filter cake, occurs can be reduced by drilling with the NAF operations fluids disclosed herein incorporating organo-anionic surfactants. The disclosed NAF operations fluids incorporating organo-anionic surfactants form filter cakes of low elasticity so that impact on injectivity is minimized and injectivity enhancement treatments are effective. Still additionally or alternatively, the operations fluids herein may be adapted to provide a pre-treatment to alter the wettability of the NAF filter cake and/or to extract non-aqueous fluid from the NAF filter cake.

As still another example of implementations utilizing NAF compositions incorporating organo-anionic surfactants, the present compositions including organo-anionic surfactants may be useful in remediating gravel packs and screens following completion operations. Well completions are generally designed to prevent the collapse of sand formations that are unstable under flowing conditions and to prevent the flow of formation sand into the production casing, among other reasons. This may be accomplished by packing the area between the casing and borehole with additional permeable sand to hold the borehole open, or to screen out any native sand that becomes free to travel with the inflow. This packing is referred to as a “gravel pack.” Various forms of screens or slotted pipe are then used to prevent the gravel pack itself from flowing into the casing. In some cases, there is no gravel pack required and fine screens alone are used to prevent the influx of native sand.

If NAF filter cake invades the formation while drilling, or if the NAF filter cake remains after the gravel pack operation, or if a NAF filter cake is formed during the completions operations, such as by using a NAF fluid to place the gravel pack, the NAF filter cakes must then flow back through the gravel pack or screens. The return flow of the filter cake is related to the size distribution of the particles from the filter cake relative to the openings between the sand grains or in other completion equipment or systems. However, continuing the theme of the foregoing examples, the elasticity of the NAF filter cake has been seen to have an impact on the return flow of the filter cake. When free standing screens are used instead of a gravel pack, the openings are typically about 200 microns in size. The particles in the NAF filter cake are typically less than 100 microns, so they should be able to pass through without plugging the screens. However, it is observed that screens do become plugged with NAF filter cake in field operations. This observation is explained by the current recognition of the NAF filter cake as an elastic material comprised of oil and solids.

By drilling and/or completing with the NAF operations fluids incorporating organo-anionic surfactants, such as described herein, the elasticity of NAF filter cakes that may limit productivity can be reduced. The disclosed NAF operations fluids incorporating organo-anionic surfactant(s) forms filter cakes of low elasticity, which contributes to performance. For example, the particulates of the filter cake can be flowed back through the gravel pack and/or screens more readily, by formation fluids and/or treatment fluids. Additionally or alternatively, the use of the present operations fluids, and specifically aqueous fluids incorporating organo-anionic surfactants, may be used to alter the properties of the filter cake to make it water wetting to facilitate conventional filter cake treatments. Still additionally or alternatively, the application of the present operations fluids may improve the permeability of the NAF filter cake sufficiently that production rates are acceptable. For example, the skin may be reduced from a grade of 3 to a grade of 1.

While the present organo-anionic surfactants may be incorporated into the NAF operations fluids to alter the properties of the resulting NAF filter cake, the organo-anionic surfactants may be used in an aqueous fluid or a non-aqueous fluid as a remediation or treatment fluid, such as in a treatment pill that may be pumped during a drilling operation or as part of a remediation or workover operation. Exemplary implementations of organo-anionic surfactants as treatment fluids were described above in various contexts. The diversity of situations in which a well may need to be treated and/or worked over and the diversity of situations in which a filter cake, and a NAF filter cake in particular, may contribute to the problem do not permit of an exhaustive listing. However, it should be noted that the ability of the present organo-anionic surfactants to reduce filter cake elasticity, to increase filter cake permeability, to change filter cake wettability, and/or to extract non-aqueous fluid from a NAF filter cake renders it suitable as a treatment fluid, alone or in conjunction with other treatment fluids, in a diversity of common operations.

The foregoing descriptions of methods incorporating the present organo-anionic surfactant(s) and fluids comprising the same are illustrative of the numerous methods and operations in which the present organo-anionic surfactants may find utility. The foregoing descriptions are exemplary only and not limiting of the various conventional and readily known operations that may be adapted to incorporate the organo-anionic surfactants. As can be understood from the description herein, the present operations fluids comprising organo-anionic surfactants may be useful in virtually any hydrocarbon recovery operation where the existence of a filter cake is undesirable or where the operations would be improved by increasing the permeability of the filter cake. Moreover, it should be noted that the examples described above incorporated the organo-anionic surfactants into NAF compositions and into aqueous treatment fluids for use before and/or during a variety of hydrocarbon recovery operations and the extension of the present compositions in other hydrocarbon recovery operations in other manners should not be limited by the exemplary implementations described herein. In the interest of clarity and conciseness, the present application is limited to these few representative, but non-limiting examples.

The following examples illustrate more specific methods of formulating organo-anionic surfactants and exemplary experimental results of their use. The following examples are considered to be representative of formulation methods and results that would be obtained using any of the combinations of weak acids and weak bases described herein.

### Examples

In a first example, a first organo-anionic surfactant, referred to as OA-Surf-1, is prepared and used to treat a filter cake. As a first step, a filter cake was prepared from an oil based mud using a high pressure high temperature filter press fitted with a 35 micron aloxite filter. 50 ml of an oil based mud (OBM-1) was added to the filter press and the sample heated to 200° F. A pressure of 800 psi was applied to the heated sample using nitrogen gas as the pressurizing gas and filtration started. After 30 minutes of filtration about 5 ml of clear oil was obtained as the filtrate. The cell was depressurized to ambient pressure and cooled to 100° F. The excess unfiltered OBM-1 was decanted off. This procedure generated an OBM-1 filter cake. The treatment fluid comprising an organo-anionic surfactant was then prepared. The treatment fluid was an aqueous solution having 2 wt % organo-anionic surfactant and 0.3 wt % NaCl. The organo-anionic surfactant for this example was mono-ethanol ammonium dodecyl benzene sulfonate. In the interest of clarity, this exemplary organo-anionic surfactant can be considered in the R—X—Y structure as: R=dodecyl benzene, X=−SO₃H, and Y=H₂N—CH₂—CH₂—OH. Continuing with the example, 25 ml of this treatment fluid solution was added to the filter press containing the OBM-1 filter cake. The filter cake was contacted with the treatment solution and the temperature of the solution and cake held at 200° F. at 800 psi for about 2.5 hours. After treatment with the surfactant solution the filter cake produce a remediated filter cake.

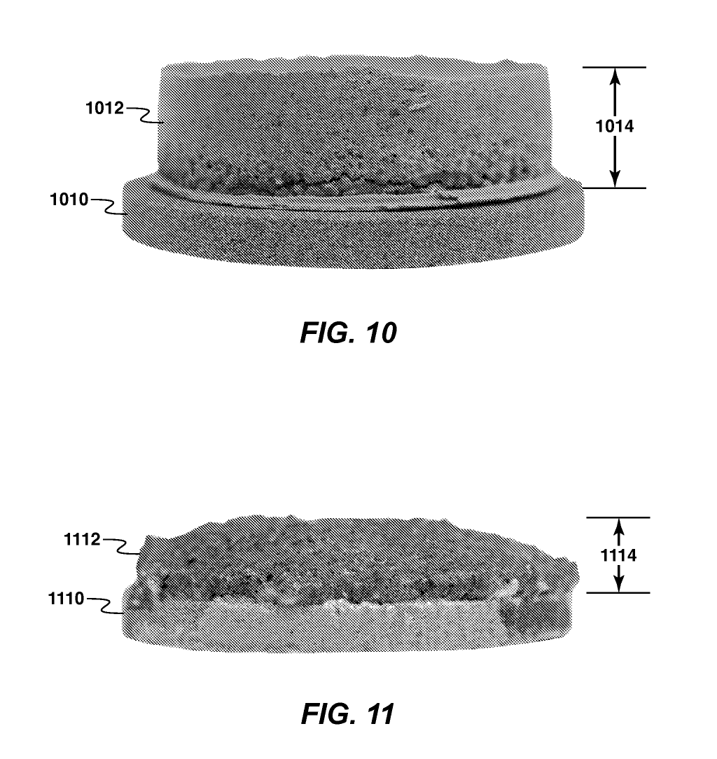

The remediated filter cake was then contacted with a high fluid loss water based mud configured after the manner of a conventional FCS pill. The FCS pill had the following components: 4.29 wt % Attapulgite clay, 4.29 wt % diatomaceous earth, 0.14 wt % Xanthan gum, and 31.42 wt % walnut hull, wherein all weight percents are based on the weight of water. Similar to the operation through which the filter cake was first formed, the FCS pill was held at 200° F. and 800 psi; the water from the FCS pill was allowed to filter through the remediated filter cake. The volume of filtrate as a function of time was noted, and is illustrated in FIG. 9. A total of about 25 ml of filtrate was collected in about 30 minutes. At the end of the experiment, the filter press was cooled and depressurized. The product of the three step process (called product cake) is shown in FIG. 10. The aloxite filter was removed leaving the filter cake 1010 and the solid components of the filtered portion of the FSC pill. These filtered solid components of the FCS pill may be referred to as the product cake 1012. The height 1014 of the product cake 1012, from the side of the filter cake, was measured. In this example, the height 1014 of the product cake 1012 was 1.8 centimeters.

In a second example of the present organo-anionic surfactants in a treatment fluid, a different organo-anionic surfactant, referred to as OA-Surf-2, was used in the steps described above. The OA-Surf-2 was mono-ethanol ammonium dodecyl carboxylate (R=dodecyl benzene, X=CO₂H, and Y=H₂N−CH₂−CH₂−OH) and it was incorporated into the treatment fluid and utilized in the same manner as above. The amount of filtrate was measured and is shown in FIG. 9; the height of the filter cake was 1.5 centimeters.

In the interest of a comparative experiment, the experiment described above was repeated using an alkali-metal anionic surfactant (a strong base, weak acid surfactant) was used instead of the organo-anionic surfactants of the present disclosure. The alkali-metal anionic surfactant was sodium dodecyl benzene sulfonic acid (NA-DBS). The product cake 1112 formed using NA-DBS in the FCS pill is illustrated in FIG. 11 on top of the filter cake 1110. The filtrate volume as a function of time is shown in FIG. 9 and the height 1114 of the product cake was 0.4 centimeters.

As yet another comparative example, the same experiment was done repeated without a surfactant. In this experiment, the filter cake was formed as described above, then treated as above using a solution of water and 0.3 wt % NaCl, then the FCS pill was applied as described above. The resulting filtrate volume as a function of time is shown in FIG. 9; the height of the product cake was measured at 0.3 centimeters.

The heights of the product cakes are aggregated in the following table for convenience. By comparing the relative heights of the product cakes and the relative filtrate volumes as a function of time, shown in FIG. 9, it can be seen that the treatment fluids comprising organo-anionic surfactant(s) of the present disclosure are able to remediate the filter cake three to four times better than the conventional treatment fluids using alkali-metal anionic surfactants. Considering that the conventional treatment fluids are formed using strong bases while the present organo-anionic surfactants use weak bases, the dramatic improvement in remediation ability is counter-intuitive.

While the present techniques of the invention may be susceptible to various modifications and alternative forms, the exemplary embodiments discussed above have been shown by way of example. However, it should again be understood that the invention is not intended to be limited to the particular embodiments disclosed herein. Indeed, the present techniques of the invention are to cover all modifications, equivalents, and alternatives falling within the spirit and scope of the invention as defined by the following appended claims.

In the present disclosure, several of the illustrative, non-exclusive examples of methods have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities, other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” may mean A alone, B alone, C alone, A and B together, A and C together, B and C together, A, B and C together, and optionally any of the above in combination with at least one other entity.

Illustrative, non-exclusive examples of systems and methods according to the present disclosure are presented in the following numbered paragraphs. It is within the scope of the present disclosure that the individual steps of the methods recited herein, including in the following numbered paragraphs, may additionally or alternatively be referred to as a “step for” performing the recited action.

1. An operations fluid for use in operations on wells associated with hydrocarbon production, the fluid comprising:

a non-aqueous fluid; and

at least one organo-anionic surfactant.

2. The operations fluid of paragraph 1, wherein the operations fluid is adapted to perform as a treatment fluid for use during at least one of drilling operations, completion operations, production operations, and injection operations.

3. The operations fluid of paragraph 2, wherein the treatment fluid is adapted to reduce the elasticity of a NAF filter cake.

4. The operations fluid of paragraph 1, wherein the organo-anionic surfactant has the general formula:

{R—X}⁻ ⁺{Y}

wherein R is selected from the group comprising linear and branched alkyl and aryl alkyl hydrocarbon chains, wherein X is an acid selected from the group comprising sulfonic acids, carboxylic acids, phosphoric acids, and mixtures thereof, and wherein Y is an organic amine selected from the group comprising monoethanol amine, diethanol amine, triethanol amine, ethylene diamine, propylene diamine, diethylene tri-amine, tri-ethylene tetra-amine, tetra ethylene pent-amine, dipropylene tri-amine, tripropylene tetra-amine, tetra propylene pentamine, and mixtures thereof.

5. The operations fluid of paragraph 4, wherein the organo-anionic surfactant is prepared by contacting the acid and the organic amine at temperatures in the range of about −50° C. to about 200° C.

6. The operations fluid of paragraph 4, wherein the organo-anionic surfactant is prepared by contacting a neat acid and s neat organic amine, wherein the acid is present relative to the organic amine at least at a molar equivalent.

7. The operations fluid of paragraph 4, wherein the organic amine is selected from one or more of monoethanol amine, diethanol amine, triethanol amine, and mixtures thereof.

8. The operations fluid of paragraph 4, wherein the organo-anionic surfactant is present in the non-aqueous fluid at a concentration greater than about 0.01 wt % and less than about 12.0 wt % based on non-aqueous fluid in the operations fluid.

9. The operations fluid of paragraph 8, wherein the organo-anionic surfactant is present in the non-aqueous fluid at a concentration greater than about 0.01 wt % and less than about 3.0 wt %.

10. The operations fluid of paragraph 4, wherein the organo-anionic surfactant is selected from the group comprising monoethanol ammonium alkyl aromatic sulfonic acid, monoethanol ammonium alkyl carboxylic acid, and mixtures thereof.

11. The operations fluid of paragraph 10, wherein the alkyl group of the acid has a length ranging from about 6 carbon atoms to about 18 carbon atoms.

12. The operations fluid of paragraph 10, wherein the alkyl group of the acid has a length ranging from about 10 carbon atoms to about 14 carbon atoms.

13. The operations fluid of paragraph 10, wherein the alkyl group of R is an alkyl chain of length at least substantially equal to a hydrocarbon chain length in a non-aqueous fluid in a filter cake formed during operation of a well.

14. A method of remediating a NAF filter cake in a well, the method comprising:

obtaining an operations fluid comprising an organo-anionic surfactant in a non-aqueous fluid;

pumping a volume of the operations fluid into a well including a NAF filter cake, wherein the volume of operations fluid is pumped to contact the NAF filter cake.

15. The method of paragraph 14, wherein the NAF filter cake is disposed on at least one of a fracture face, a sand screen, gravel pack components, and a wellbore wall.

16. The method of paragraph 14, wherein the remediation method is applied during at least one of clean-up operations and workover operations to reduce an effective skin effect caused by the NAF filter cake.

17. The method of paragraph 14, wherein the volume of the operations fluid is applied during at least one of drilling operations, completion operations, production operations, and injection operations.

18. The method of paragraph 17, wherein the well includes an open hole segment, wherein the NAF filter cake is formed on a wellbore wall in the open hole segment, and wherein the operations fluid is applied to the open hole segment.

19. The method of paragraph 17, wherein the well includes sand control equipment, wherein the NAF filter cake is formed on at least one component of the sand control equipment, and wherein the operations fluid is applied to contact the at least one component of the sand control equipment.

20. The method of paragraph 14, wherein the organo-anionic surfactant has the general formula:

{R—X}⁻ ⁺{Y}

wherein R is selected from the group comprising linear and branched alkyl and aryl alkyl hydrocarbon chains, wherein X is an acid selected from the group comprising sulfonic acids, carboxylic acids, phosphoric acids, and mixtures thereof, and wherein Y is an organic amine selected from the group comprising monoethanol amine, diethanol amine, triethanol amine, ethylene diamine, propylene diamine, diethylene tri-amine, tri-ethylene tetra-amine, tetra ethylene pent-amine, dipropylene tri-amine, tripropylene tetra-amine, tetra propylene pentamine, and mixtures thereof.

21. The method of paragraph 20, wherein the organo-anionic surfactant is prepared by contacting a neat organic acid and a neat organic amine, wherein the organic acid is present relative to the organic amine at least at a molar equivalent.

22. The method of paragraph 20, wherein the organo-anionic surfactant is present in the non-aqueous fluid at a concentration greater than about 0.01 wt % and less than about 12.0 wt % based on non-aqueous fluid in the operations fluid.

23. The method of paragraph 22, wherein the organo-anionic surfactant is present at a concentration greater than about 0.01 wt % and less than about 3.0 wt %.

24. The method of paragraph 20, wherein the organo-anionic surfactant is selected from the group comprising monoethanol ammonium alkyl aromatic sulfonic acid, monoethanol ammonium alkyl carboxylic acid, and mixtures thereof.

25. The method of paragraph 24, wherein the alkyl group of R is an alkyl chain of length at least substantially equal to a hydrocarbon chain length in a non-aqueous fluid in the NAF filter cake.

26. A method of producing hydrocarbons from a well, the method comprising:

drilling through a formation using a NAF-based drilling fluid to form a well, wherein a NAF filter cake is formed on at least one component of the well;

treating the at least one component of the well with an operations fluid comprising an organo-anionic surfactant in a non-aqueous fluid to remediate the NAF filter cake; and

producing hydrocarbons through the well.

27. The method of paragraph 26, wherein the organo-anionic surfactant has the general formula:

{R—X}⁻ ⁺{Y}

wherein R is selected from the group comprising linear and branched alkyl and aryl alkyl hydrocarbon chains, wherein X is an acid selected from the group comprising sulfonic acids, carboxylic acids, phosphoric acids, and mixtures thereof, and wherein Y is an organic amine selected from the group comprising monoethanol amine, diethanol amine, triethanol amine, ethylene diamine, propylene diamine, diethylene tri-amine, tri-ethylene tetra-amine, tetra ethylene pent-amine, dipropylene tri-amine, tripropylene tetra-amine, tetra propylene pentamine, and mixtures thereof.

28. The method of paragraph 26, wherein the operations fluid is mixed with the drilling fluid to alter one or more properties of the NAF filter cake.

### INDUSTRIAL APPLICABILITY

The systems and methods described herein are applicable to the oil and gas industry.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

What is claimed is:

1. An operations fluid for use in operations on wells associated with hydrocarbon production, the fluid comprising:
a non-aqueous fluid; and
at least one organo-anionic surfactant.

2. The operations fluid of claim 1, wherein the operations fluid is adapted to perform as a treatment fluid for use during at least one of drilling operations, completion operations, production operations, and injection operations.

3. The operations fluid of claim 2, wherein the treatment fluid is adapted to reduce the elasticity of a NAF filter cake.

4. The operations fluid of claim 1, wherein the organo-anionic surfactant has the general formula:
{R—X}⁻ ⁺{Y}
wherein R is selected from the group comprising linear and branched alkyl and aryl alkyl hydrocarbon chains, wherein X is an acid selected from the group comprising sulfonic acids, carboxylic acids, phosphoric acids, and mixtures thereof, and wherein Y is an organic amine selected from the group comprising monoethanol amine, diethanol amine, triethanol amine, ethylene diamine, propylene diamine, diethylene tri-amine, tri-ethylene tetra-amine, tetra ethylene pent-amine, dipropylene tri-amine, tripropylene tetra-amine, tetra propylene pentamine, and mixtures thereof.

5. The operations fluid of claim 4, wherein the organo-anionic surfactant is prepared by contacting the acid and the organic amine at temperatures in the range of about −50° C. to about 200° C.

6. The operations fluid of claim 4, wherein the organo-anionic surfactant is prepared by contacting a neat acid and a neat organic amine, wherein the acid is present relative to the organic amine at least at a molar equivalent.

7. The operations fluid of claim 4, wherein the organic amine is selected from one or more of monoethanol amine, diethanol amine, triethanol amine, and mixtures thereof.

8. The operations fluid of claim 4, wherein the organo-anionic surfactant is present in the non-aqueous fluid at a concentration greater than about 0.01 wt % and less than about 12.0 wt % based on non-aqueous fluid in the operations fluid.

9. The operations fluid of claim 8, wherein the organo-anionic surfactant is present in the non-aqueous fluid at a concentration greater than about 0.01 wt % and less than about 3.0 wt %.

10. The operations fluid of claim 4, wherein the organo-anionic surfactant is selected from the group comprising monoethanol ammonium alkyl aromatic sulfonic acid, monoethanol ammonium alkyl carboxylic acid, and mixtures thereof.

11. The operations fluid of claim 10, wherein the alkyl group of the acid has a length ranging from about 6 carbon atoms to about 18 carbon atoms.

12. The operations fluid of claim 10, wherein the alkyl group of the acid has a length ranging from about 10 carbon atoms to about 14 carbon atoms.

13. The operations fluid of claim 10, wherein the alkyl group of R is an alkyl chain of length at least substantially equal to a hydrocarbon chain length in a non-aqueous fluid in a filter cake formed during operation of a well.

14. A method of remediating a NAF filter cake in a well, the method comprising:
obtaining an operations fluid comprising an organo-anionic surfactant in a non-aqueous fluid;
pumping a volume of the operations fluid into a well including a NAF filter cake, wherein the volume of operations fluid is pumped to contact the NAF filter cake.

15. The method of claim 14, wherein the NAF filter cake is disposed on at least one of a fracture face, a sand screen, gravel pack components, and a wellbore wall.

16. The method of claim 14, wherein the remediation method is applied during at least one of clean-up operations and workover operations to reduce an effective skin effect caused by the NAF filter cake.

17. The method of claim 14, wherein the volume of the operations fluid is applied during at least one of drilling operations, completion operations, production operations, and injection operations.

18. The method of claim 17, wherein the well includes an open hole segment, wherein the NAF filter cake is formed on a wellbore wall in the open hole segment, and wherein the operations fluid is applied to the open hole segment.

19. The method of claim 17, wherein the well includes sand control equipment, wherein the NAF filter cake is formed on at least one component of the sand control equipment, and wherein the operations fluid is applied to contact the at least one component of the sand control equipment.

20. The method of claim 14, wherein the organo-anionic surfactant has the general formula:
{R—X}⁻ ⁺{Y}
wherein R is selected from the group comprising linear and branched alkyl and aryl alkyl hydrocarbon chains, wherein X is an acid selected from the group comprising sulfonic acids, carboxylic acids, phosphoric acids, and mixtures thereof, and wherein Y is an organic amine selected from the group comprising monoethanol amine, diethanol amine, triethanol amine, ethylene diamine, propylene diamine, diethylene tri-amine, tri-ethylene tetra-amine, tetra ethylene pent-amine, dipropylene tri-amine, tripropylene tetra-amine, tetra propylene pentamine, and mixtures thereof.

21. The method of claim 20, wherein the organo-anionic surfactant is prepared by contacting a neat organic acid and a neat organic amine, wherein the organic acid is present relative to the organic amine at least at a molar equivalent.

22. The method of claim 20, wherein the organo-anionic surfactant is present in the non-aqueous fluid at a concentration greater than about 0.01 wt % and less than about 12.0 wt % based on non-aqueous fluid in the operations fluid.

23. The method of claim 22, wherein the organo-anionic surfactant is present at a concentration greater than about 0.01 wt % and less than about 3.0 wt %.

24. The method of claim 20, wherein the organo-anionic surfactant is selected from the group comprising monoethanol ammonium alkyl aromatic sulfonic acid, monoethanol ammonium alkyl carboxylic acid, and mixtures thereof.

25. The method of claim 24, wherein the alkyl group of R is an alkyl chain of length at least substantially equal to a hydrocarbon chain length in a non-aqueous fluid in the NAF filter cake.

26. A method of producing hydrocarbons from a well, the method comprising:
drilling through a formation using a NAF-based drilling fluid to form a well, wherein a NAF filter cake is formed on at least one component of the well;
treating the at least one component of the well with an operations fluid comprising an organo-anionic surfactant in a non-aqueous fluid to remediate the NAF filter cake; and
producing hydrocarbons through the well.

27. The method of claim 26, wherein the organo-anionic surfactant has the general formula:
{R—X}⁻ ⁺{Y}
wherein R is selected from the group comprising linear and branched alkyl and aryl alkyl hydrocarbon chains, wherein X is an acid selected from the group comprising sulfonic acids, carboxylic acids, phosphoric acids, and mixtures thereof, and wherein Y is an organic amine selected from the group comprising monoethanol amine, diethanol amine, triethanol amine, ethylene diamine, propylene diamine, diethylene tri-amine, tri-ethylene tetra-amine, tetra ethylene pent-amine, dipropylene tri-amine, tripropylene tetra-amine, tetra propylene pentamine, and mixtures thereof.

28. The method of claim 26, wherein the operations fluid is mixed with the drilling fluid to alter one or more properties of the NAF filter cake.
